(19) United States
(12) Patent Application Publication
(10) Pub. No.: US 2004/0141657 A1
(43) Pub. Date: Jul. 22, 2004

(54) Image processing to remove red-eye features

(76) Inventor: Nick Jarman, Hampshire (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/416,367

(22) PCT Filed: Jan. 3, 2003
(86) PCT No.: PCT/GB03/00005

(30) Foreign Application Priority Data
Jan. 24, 2002 (GB) 0201634.3

(51) Int. Cl. G06K 9/40

(52) U.S. Cl. 382/275

(57) ABSTRACT

A method of providing feedback to the viewer of a digital image across which a pointer (7) is movable by the viewer comprises identifying red-eye pixels (10) less than a predetermined distance from the pointer having one or more parameters falling within a predetermined range of values, and determining if each of said red-eye pixels (10) form part of a larger correctable red-eye feature (6). It is then indicated to the viewer that the correctable red-eye feature is present, without the need for any further interaction from the viewer.

This invention relates to image processing to remove red-eye features, and in particular to the use of feedback to aid interactive removal of red-eye features from a digital image.

The phenomenon of red-eye in photographs is well-known. When a flash is used to illuminate a person (or animal), the light is often reflected directly from the subject's retina back into the camera. This causes the subject's eyes to appear red when the photograph is displayed or printed.

Photographs are increasingly stored as digital images, typically as arrays of pixels, where each pixel is normally represented by a 24-bit value. The colour of each pixel may be encoded within the 24-bit value as three 8-bit values representing the intensity of red, green and blue for that pixel. Alternatively, the array of pixels can be transformed so that the 24-bit value consists of three 8-bit values representing “hue”, “saturation” and “lightness”. Hue provides a “circular” scale defining the colour, so that 0 represents red, with the colour passing through green and blue as the value increases, back to red at 255. Saturation provides a measure of the intensity of the colour identified by the hue. Lightness can be seen as a measure of the amount of illumination.

By manipulation of these digital images it is possible to reduce the effects of red-eye. Software which performs this task is well known, and generally works by altering the pixels of a red-eye feature so that their red content is reduced. Normally they are left as black or dark grey instead. This can be achieved by reducing the lightness and/or saturation of the red areas.

Most red-eye reduction software requires the centre and radius of each red-eye feature which is to be manipulated, and the simplest way to provide this information is for a user to select the central pixel of each red-eye feature and indicate the radius of the red part. This process can be performed for each red-eye feature, and the manipulation therefore has no effect on the rest of the image. However, this requires considerable input from the user, and it is difficult to pinpoint the precise centre of each red-eye feature, and to select the correct radius.

In an alternative method for identifying and correcting red-eye features, a user identifies a red-eye to be corrected by pointing to it with the mouse and clicking. The click triggers a process which detects the presence and extent of the area to be corrected, then goes on to perform the correction if a correctable area was found. The software examines the pixels around that selected by the user, to discover whether or not the user has indeed selected part of a red-eye feature. This can be done by checking to see whether or not the pixels in the region around the selected pixel are of a hue (i.e. red) consistent with a red-eye feature. If this is the case, then the extent of the red area is determined, and corrected in a standard fashion. No action other than pointing to the eye and clicking on it is necessary.

Although this reduces the burden on a user for identifying and correcting red-eye features, an element of trial and error still exists. Once the user has clicked on or near a red-eye feature, if the software finds that feature, it will be corrected. If no red-eye feature could be found (possibly because the user clicked in an area not containing a red-eye feature, or because the software was not able to detect a red-eye feature which was present), the user is informed by some means, for example, a message in a dialogue box. The user might then try to identify the same feature as a red-eye feature by clicking in a slightly different place. There are currently no methods of red-eye detection which can guarantee to identify all red-eyes in a click-and-correct environment, which means that users must accept that there is some element of trial and error in the process.

In accordance with a first aspect of the present invention there is provided a method of providing feedback to the viewer of a digital image across which a pointer is movable by the viewer, the method comprising identifying red-eye pixels less than a predetermined distance from the pointer having one or more parameters falling within a predetermined range of values, determining if each of said red-eye pixels form part of a larger correctable red-eye feature, and indicating to the viewer that said correctable red-eye feature is present. The method preferably also includes identifying the extent of the correctable red-eye feature.

Therefore if an indication is made to the viewer that there is a correctable red-eye feature in the vicinity of his pointer, he knows that a click with the pointer in its current position will lead to a red-eye feature being corrected.

The step of identifying the red-eye pixels may conveniently be carried out every time the pointer is moved. This means that there is no need to constantly check for possible red-eye features, and the check need only be made every time the pointer moves to a new location.

The presence of the correctable red-eye feature may be indicated to the viewer by means of an audible signal. Alternatively or in addition, a marker may be superimposed over the red-eye feature. This marker may be larger than the red-eye feature so as to ensure it is not too small to see or obscured by the pointer. The viewer may be provided with a preview of the corrected feature. Alternatively or in addition, the shape of the pointer may be changed.

The step of determining if each of said red-eye pixels forms part of a correctable red-eye feature preferably includes investigating the pixels around each identified red-eye pixel to search for a closed area in which all the pixels have one or more parameters within a predetermined range of values. This can be done using any known method for identifying a uniform or nearly uniform area. If more than one red-eye pixel is found to belong to the same correctable red-eye feature, only one red-eye feature is indicated to the viewer as being present. This prevents attempts to locate and correct for the same red-eye feature many times.

The parameters searched may be some or all of hue, saturation and lightness, and the predetermined range of values preferably corresponds to the types of red found in red-eye features. Thus preferred embodiments of the invention involve searching for a red pixel near to the pointer, and identifying whether or not this red pixel forms part of a larger red area. If so, then an indication is made to the viewer that if he clicks at that point it may be possible to correct aired-eye feature.

The correctable red-eye feature is preferably corrected in response to selection by the viewer, for example by a mouse click.

In accordance with other aspects of the invention there is provided apparatus arranged to perform a method as described above, and a computer storage medium having stored thereon a program arranged when executed on a processor to carry out the method described above.

Thus preferred embodiments of the invention provide feedback when the user moves a mouse so that the pointer points to an area inside or near a red-eye feature which can be corrected. The feedback gives the user a clear indication that a click will result in the eye being corrected. This saves time because the user is not required to guess or make several attempts at finding where to click in order to perform a correction. The user can always be sure whether or not a click will result in a correction. A further advantage of this approach is that it is not necessary for the user to zoom in on the picture to accurately nominate a pixel-the feedback will inform them when they are close enough. Eliminating the need to zoom in, and consequently the need to pan around the zoomed view, further increases efficiency.

Some preferred embodiments of the invention will now be described by way of example only and with reference to the accompanying drawings, in which:

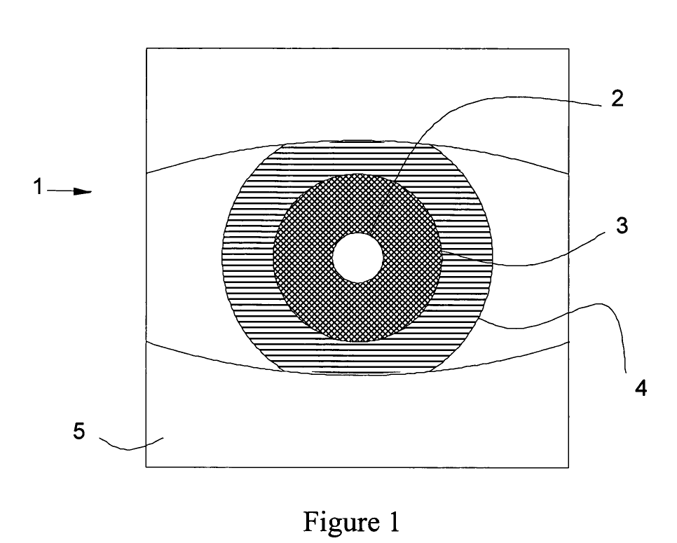

FIG. 1 is a schematic diagram showing a red-eye feature;

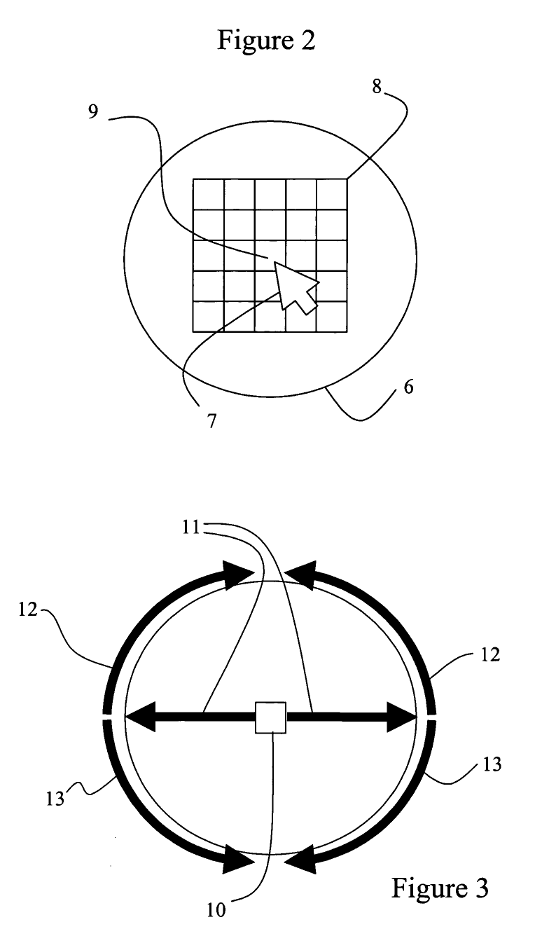

FIG. 2 is a schematic diagram showing a red-eye feature with a mouse pointer located within the feature;

FIG. 3 is a schematic diagram showing how the extent of the red-eye feature is determined;

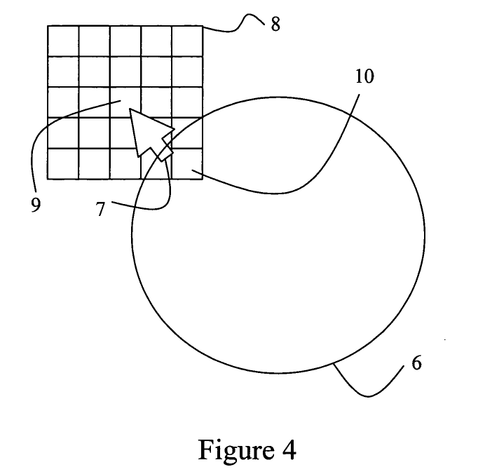

FIG. 4 is a schematic diagram showing a red-eye feature with a mouse pointer located outside the feature;

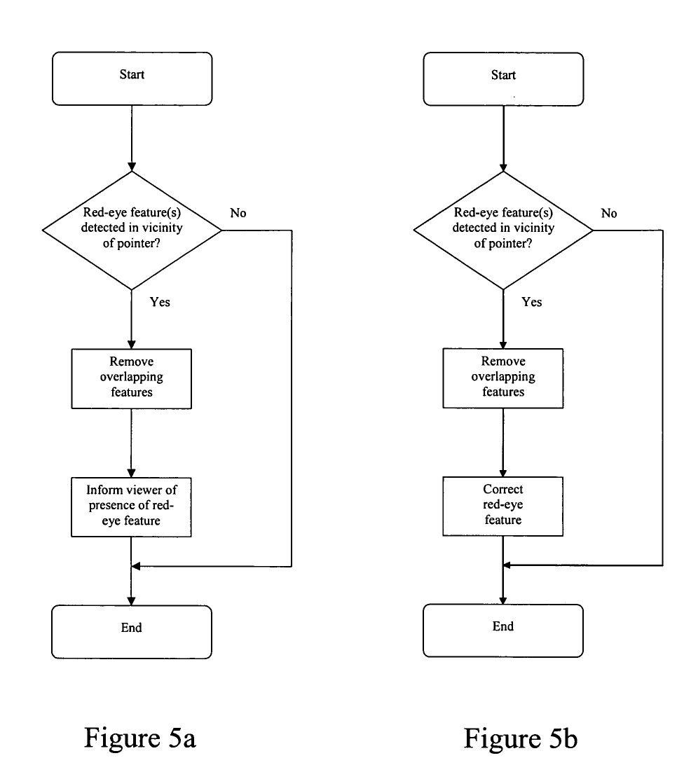

FIG. 5a is a flow chart showing the steps involved in indicating the presence of a red-eye feature to a user following a mouse movement; and

FIG. 5b is a flow chart showing the steps involved in correcting a red-eye feature following a mouse click.

FIG. 1 is a schematic diagram showing a typical red-eye feature 1. At the centre of the feature 1 there is often a white or nearly white “highlight” 2, which is surrounded by a region 3 corresponding to the subject's pupil. In the absence of red-eye, this region 3 would normally be black, but in a red-eye feature this region 3 takes on a reddish hue. This can range from a dull glow to a bright red. Surrounding the pupil region 3 is the iris 4, some or all of which may appear to take on some of the red glow from the pupil region 3. For the purposes of the following discussion, the term “red-eye feature” will be used to refer generally to the red part of the feature 1 shown in FIG. 1. This will generally be a circular (or nearly circular) region consisting of the pupil region 3 and possibly some of the iris region 4.

When a viewer looks at the image, he has available to him a pointer which can be moved over the image, usually by means of a mouse. Before the image is displayed to the viewer it is transformed so that each pixel is represented by its hue, saturation and lightness values. Every time the mouse is moved, the new position of the pointer is noted and a check is made to determine whether or not a possible red-eye feature is located nearby.

FIG. 2 shows the situation when the pointer 7 is located at the centre of a red-eye feature 6. A grid of pixels 8 (in this case 5 pixels×5 pixels) is selected so that the pointer 7 points to the pixel 9 at the centre of the grid 8. Each of these pixels is checked in turn to determine whether it might form part of a correctable red-eye feature. The above procedure can be represented by an algorithm as follows:

```
MouseMove(MouseX, MouseY)
    ExtraPixels = 2
    create empty list of points to check
    for Y = MouseY − ExtraPixels to MouseY + ExtraPixels
        for X = MouseX − ExtraPixels to MouseX + ExtraPixels
            add X, Y to list of points to check
        next
    next
    DetectArea(list of points to check)
end MouseMove
```

The check is a straightforward check of the values of the pixel. If the values are as follows:

220≦Hue≦255, or 0≦Hue≦10, and

Saturation≧80, and

Lightness<200, then the pixel is “correctable” and might form part of a correctable feature. Even if the pixel is part of the highlight region 2 (shown in FIG. 1) then it may still have these properties, in which case the red-eye feature would still be detected. In any event, highlight regions are generally so small that even if pixels within them do not have the required properties, one of the other pixels in the 5×5 pixel grid will fall outside the highlight region but still within the red-eye feature 6, and should therefore have “correctable” properties, so the feature will still be detected.

If any of the pixels satisfy the conditions as set out above, then a check is made to determine whether this pixel forms part of a area which might be formed by red-eye. This is performed by checking to see whether the pixel is part of an isolated, roughly circular, area, most of whose pixels have values satisfying the criteria set out above. There are a number of known methods for determining the existence and extent of an area so this will not be described in detail here. The check should take account of the fact that there may be a highlight region, whose pixels may not be “correctable”, somewhere within the isolated area corresponding to the red-eye feature.

One method of determining the extent of the area is illustrated in FIG. 3 and involves moving outwards from the starting “correctable” pixel 10 along a row of pixels 11, continuing until a pixel which does not meet the selection criteria (i.e. is not classified as correctable) is encountered at the edge of the feature 6. It is then possible to move 12, 13 around the edge of the red-eye feature 6, following the edge of the correctable pixels until the whole circumference has been determined. If there is no enclosed area, or if the area is smaller than or larger than predetermined limits, or not sufficiently circular, then it is not identified as a correctable red-eye feature.

A similar check is then performed starting at each of the other pixels originally identified as being sufficiently “correctable” that they might form part of a red-eye feature. It will be appreciated that if all 25 pixels in the original grid are within the feature and detected as such, the feature will be identified 25 times. Even if this is not the case, the same feature may be detected more than once. In such a case, the “overlapping” features are discounted until only one remains.

FIG. 4 shows the situation where the mouse pointer is located outside the red-eye feature 6. Since a 5×5 pixel grid 8 is checked for correctable pixels, at least one of the pixels 10 falls within the red-eye feature and may have hue, saturation and lightness values satisfying the conditions set out above. The extent of the feature can then be determined in the same way as before.

If a red-eye feature 6 is identified close to the pointer 7 as described above, the user is informed of this fact. The way in this information is passed to the user may include any or all of the following means of feedback:

An audible signal

A circle and/or crosshair superimposed over the red-eye feature. It is likely that any indicator such as this will have to be larger than the correctable area itself, which could be too small to see clearly, and/or partly/wholly obscured by the mouse pointer. The indicator could also make use of movement to increase visibility, for example, the crosshair could be made to repeatedly grow and shrink, or perhaps to rotate.

Changing the shape of the mouse pointer. Since the pointer will be the focus of the user's attention, a change in shape will be easily noticed.

The sequence of events described above is shown as a flow chart in FIG. 5a. This sequence of events is triggered by a “mouse movement” event returned by the operating system.

If the user then clicks the mouse with the pointer in this position, a correction algorithm is called which will apply a correction to the red-eye feature so that it is less obvious. There are a number of known methods for performing red-eye correction, and a suitable process is now described. The process described is a very basic method of correcting red-eye, and the skilled person will recognise that there is scope for refinement to achieve better results, particularly with regard to softening the edges of the corrected area.

A suitable algorithm for the red-eye corrector is as follows:

```
for each pixel within the circle enclosing the red-eye region
    if the saturation of this pixel >= 80 and...
    ...the hue of this pixel >= 220 or <= 10 then
        set the saturation of this pixel to 0
        if the lightness of this pixel < 200 then
            set the lightness of this pixel to 0
        end if
    end if
end for
```

For each pixel, there are two very straightforward checks, each with a straightforward action taken as a consequence:

1. If the pixel is of medium or high saturation, and if the hue of the pixel is within the range of reds, the pixel is de-saturated entirely. In other words, saturation is set to “0” which causes red pixels to become grey.

2. Furthermore, if the pixel is dark or of medium lightness, turn it black. In most cases, this actually cancels out the adjustment made as a result of the first check: most pixels in the red-eye region will be turned black. Those pixels which are not turned black are the ones in and around the highlight. These will have had any redness removed from them, so the result is an eye with a dark black pupil and a bright white highlight.

A feature of the correction method is that its effects are not cumulative: after correction is applied to an area, subsequent corrections to the same area will have no effect. This also means that after a red-eye feature is corrected, if the mouse is moved near to that feature again, it will not be detected.

The sequence of events involved in correcting a red-eye feature are shown as a flow chart in FIG. 5b. This sequence of events is triggered by a “mouse click” event returned by the operating system.

A preview of the corrected red-eye feature could also be displayed to the user before the full correction takes place, for example as part of the process of informing the user that there is a correctable feature near the pointer. The user could then see what effect clicking the mouse will have on the image.

It will be appreciated that variations of the above described embodiments may still fall within the scope of the invention. For example, as shown in FIG. 1, many features formed by red-eye include a “highlight” at the centre. It may therefore be convenient to search for this highlight in the vicinity of the mouse pointer instead of, or in addition to, searching for “red” pixels, to determine whether or not a red-eye feature might be present.

In the described embodiments the search for a correctable red-eye feature is triggered by a “mouse movement” event. It will be appreciated that other events could trigger such a search, for example the mouse pointer staying in one place for longer than a predetermined period of time.

In the embodiments described above, the image is transformed so that all its pixels are represented by hue, saturation and lightness values before any further operations are performed. It will be appreciated that this is not always necessary. For example, the pixels of the image could be represented by red, green and blue values. The pixels around the pointer, which are checked to see if they could be part of a red-eye feature, could be transformed into their hue, saturation and lightness values when this check is made. Alternatively the check could be made using predetermined ranges of red, green and blue, although the required ranges are generally simpler if the pixels are represented by hue, saturation and lightness.

1. A method of providing feedback to the viewer of a digital image across which a pointer is movable by the viewer, the method comprising:
identifying red-eye pixels less than a predetermined distance from the pointer having one or more parameters falling within a predetermined range of values;
determining if each of said red-eye pixels form part of a larger correctable red-eye feature; and
indicating to the viewer that said correctable red-eye feature is present, without any further interaction from the viewer.

2. A method as claimed in claim 1, wherein the step of identifying the red-eye pixels is carried out every time the pointer is moved.

3. A method as claimed in claim 1 or 2, further comprising identifying the extent of the correctable red-eye feature.

4. A method as claimed in claim 1, 2 or 3, wherein the presence of the correctable red-eye feature is indicated to the viewer by means of an audible signal.

5. A method as claimed in any preceding claim, wherein the presence of the correctable red-eye feature is indicated to the viewer by means of a marker superimposed over the red-eye feature.

6. A method as claimed in claim 5, wherein the marker is larger than the red-eye feature.

7. A method as claimed in any preceding claim, wherein indication to the viewer of the presence of the correctable red-eye feature includes making a correction to the red-eye feature and displaying the corrected red-eye feature.

8. A method as claimed in any preceding claim, wherein the indication to the viewer of the presence of a correctable red-eye feature includes changing the shape of the pointer.

9. A method as claimed in any preceding claim, wherein the step of determining if each of said identified red-eye pixels forms part of a correctable red-eye feature includes investigating the pixels around each red-eye pixel to search for a closed area in which all the pixels have one or more parameters within a predetermined range of values.

10. A method as claimed in claim 9, wherein if more than one red-eye pixel is found to belong to the same correctable red-eye feature, only one red-eye feature is indicated to the viewer as being present.

11. A method as claimed in any preceding claim, wherein the one or more parameters include hue.

12. A method as claimed in any preceding claim, wherein the one or more parameters include saturation.

13. A method as claimed in any preceding claim, wherein the one or more parameters include lightness.

14. A method as claimed in claim 11, 12 or 13, wherein the predetermined range of values corresponds to the types of red found in red-eye features.

15. A method as claimed in any preceding claim, further comprising correcting the correctable red-eye feature in response to selection by the viewer.

16. A method as claimed in claim 15, wherein selection by the viewer comprises a mouse click.

17. Apparatus arranged to perform the method of any preceding claim.

18. A computer storage medium having stored thereon a program arranged when executed on a processor to carry out the method of any of claims 1 to 16.

19. A method as described herein with reference to the accompanying drawings.
